(19) United States
(12) Patent Application Publication
(10) Pub. No.: US 2024/0005359 A1
(43) Pub. Date: Jan. 4, 2024

(54) Projected Advertisement Modification

(71) Applicant: GM Cruise Holdings LLC, San Francisco, CA (US)

(72) Inventors: Andrew David Acosta, San Francisco, CA (US); Krishal Parikh, San Francisco, CA (US)

(73) Assignee: GM Cruise Holdings LLC, San Francisco, CA (US)

(21) Appl. No.: 17/855,741

(22) Filed: Jun. 30, 2022

(51) Int. Cl. G06Q 30/02; G09F 21/04; G09F 13/10

(52) U.S. Cl. CPC G06Q 30/0271; G09F 13/10; G09F 21/048; G06Q 30/0266

(57) ABSTRACT

Systems and methods for changing a view of selected advertisements visible from a vehicle. In particular, systems and methods are provided to detect outdoor advertisements visible from inside a vehicle, and cover, replace, and/or enhance the detected advertisements. In some examples, advertisements can be blocked, replaced and/or enhanced by projecting images onto the interior window, and/or dynamically dimming selected portions of the interior window.

### BACKGROUND

### 1. Technical Field

The present disclosure generally relates to modifying vehicle views, more specifically, to changing views of advertisements visible from a vehicle.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

Autonomous vehicles can be used to provide rides to passengers for various types of errands and outings. While riding in an autonomous vehicle, passengers may see various advertisements outside the vehicle. Many of the advertisements visible to a vehicle passenger may be of little interest to the passenger, and some may be offensive or even frightening.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example of an autonomous vehicle, according to some examples of the present disclosure;

FIG. 2 illustrates a method for advertisement modification in a vehicle, according to some examples of the present disclosure;

FIG. 3 illustrates an example of the inputs to a system for advertisement modification in a vehicle, according to some examples of the present disclosure;

FIG. 4 illustrates a cutaway top view of a vehicle, according to some examples of the present disclosure;

FIG. 5 illustrates an example interface for content modification preferences, according to some examples of the present disclosure;

FIG. 6 illustrates an example system environment that can be used to facilitate autonomous vehicle (AV) dispatch and operations, according to some aspects of the disclosed technology;

FIG. 7 illustrates an example of a deep learning neural network that can be used to implement a perception module and/or one or more validation modules, according to some aspects of the disclosed technology; and

FIG. 8 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Overview

Systems and methods are provided to change selected content visible from a vehicle. In particular, systems and methods are provided to detect outdoor advertisements visible from inside a vehicle, and cover, replace, enhance and/or augment the detected advertisements. In some examples, advertisements can be blocked, replaced and/or enhanced by projecting images onto the interior window, and/or dynamically dimming selected portions of the interior window. In various examples, any content visible from inside a vehicle can be covered, replaced, enhanced, and/or augmented.

Generally, advertisements are displayed ubiquitously throughout urban environments, and the content of various advertisements may not be relevant, desired, or appropriate to many people who see them. For instance, advertisements for alcohol may not be relevant to an underage viewer and advertisements for a steakhouse may not be relevant to a vegetarian. Similarly, some viewers may prefer not to see certain advertisements for various reasons, such as personal fears or objectives. For instance, some viewers may prefer not to see advertisements for horror movies. In another example, viewers who are dieting may prefer not to see advertisements for snacks and desserts.

Additionally, viewers who are interested in a product being advertised on a billboard or other location may not remember the brand or specific product when they have a chance to look for the relevant item. For instance, if a viewer sees an advertisement during a ride to an event, the viewer may not have a chance to search for the product until after the event. By the time the viewer has time to search for the product, the viewer may have forgotten about the product entirely, and/or may have forgotten the advertised brand of the product.

Systems and methods are provided herein to identify advertisements visible from inside a vehicle, evaluate user preferences, and adjust vehicle views accordingly. For example, advertisements may be blocked or advertisements may be replaced with more relevant content. In some examples, advertisements may be enhanced by highlighting the advertisements, adding links and/or QR codes, and/or adding animated content. Additionally, in some examples, outdoor advertisements can be supplemented with related in-vehicle content, such as content on in-vehicle screens and/or tablets.

Example Autonomous Vehicle for Projected Advertisement Modifications

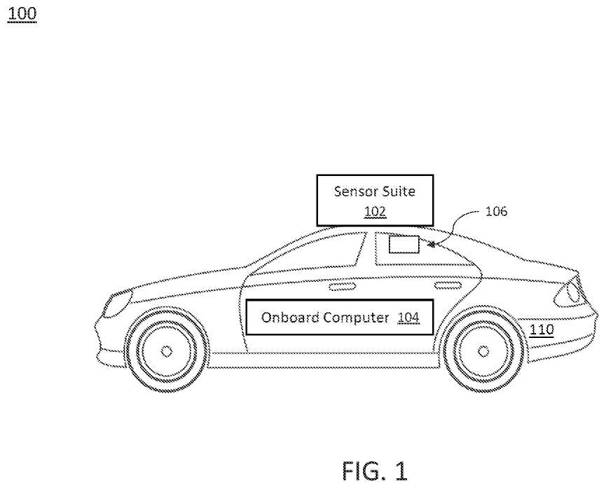

FIG. 1 is a diagram of an autonomous driving system 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. The autonomous vehicle 110 includes systems and methods for blocking, replacing, and/or enhancing advertisements visible to passengers from inside the vehicle 110. In some examples, the vehicle 110 includes an advertisement modification component 106 that detects advertisements visible from the vehicle 110, and generates alternative or enhanced content, which can be dynamically projected in the advertisement viewing area of one or more vehicle windows. In some examples, the advertisement modification component 106 receives map data including advertisement locations.

The sensor suite 102 includes localization and driving sensors. For example, the sensor suite may include one or more of photodetectors, cameras, radio detection and ranging (RADAR), sound navigation and ranging (SONAR), light detection and ranging (LIDAR), GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment. As described in greater detail below, information about the autonomous vehicle's environment as detected by the sensor suite 102 can be used identify advertisements and to block, replace, and/or enhance detected advertisements. In some examples, data from the sensor suite 102 can be used to update a map with information used to develop layers with waypoints identifying various detected items, such as detected advertisements. The data and map waypoints can be used by the advertisement modification component 106 to block or replace advertisements. Additionally, sensor suite 102 data can provide localized traffic information. In this way, sensor suite 102 data from many autonomous vehicles can continually provide feedback to the mapping system and the high fidelity map can be updated as more and more information is gathered. In some examples, the advertisement modification system provided herein can use information gathered by other autonomous vehicles in the fleet, for example information in the mapping system, for identifying advertisements and determining advertisement content, as described in greater detail below.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some examples, the advertisement modification component 106 receives processed sensed sensor suite 102 data from the onboard computer 104. In some examples, the advertisement modification component 106 receives sensor suite 102 data from the sensor suite 102. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. In some examples, the interior sensors can be used to detect passengers inside the vehicle. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, a bicycle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

Example Method for Vehicle Advertisement Modification

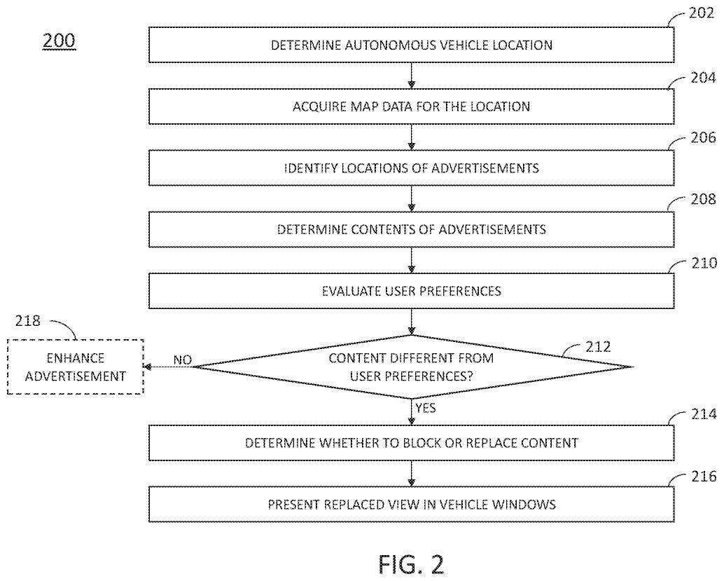

FIG. 2 illustrates a method 200 for content modification in a vehicle, according to some examples of the present disclosure. At step 202, the vehicle's location is determined. The vehicle's location can be used to determine what content is displayed in the vicinity. For example, the vehicle's location can be used to determine which advertisements are displayed in the vicinity. At step 204, the map data for the location is acquired. In particular, map data is acquired that includes information about advertisements in the vicinity of the vehicle's location.

In various examples, map data is received at the vehicle from a central computing system. The map data can be stored on the vehicle onboard computer or on another vehicle computer. The map data can be stored in an advertisement modification system computer. The map data is periodically updated. In particular, the central computer receives updated map data from vehicles in the vehicle fleet as the vehicles drive and sense environmental information, including advertisements, for example through the vehicle sensor suite. In particular, the central computer receives updated map data from fleet vehicle sensors, processes the updated information, and updates central maps. In various examples, the central computer updates its maps daily, hourly, every few minutes, or more frequently.

Additionally, the vehicle periodically requests and/or receives updated map data from the central computer. In various examples, the vehicle receives updated map data weekly, daily, hourly, before each ride, or more frequently. The map data is used by the advertisement modification system in blocking or modifying advertisements present in the environment around the vehicle.

At step 206, the locations of advertisements in the vicinity of the vehicle's location are identified on the map data and using vehicle sensors. In some examples, the locations of advertisements visible from the vehicle's location are identified. When locations of advertisements are determined, it is also determined whether the advertisement is visible to a user from inside the vehicle. Thus, in various examples, using interior vehicle sensors, the vehicle determines which vehicle seat the user is occupying, and what the user's view is from the vehicle from that position. Interior vehicle sensors can detect the position of the user's head within the vehicle. In some examples, interior vehicle sensors can determine the direction the user's head is pointing, and/or the direction of the user's gaze. The user's line of sight can be determined and this information can be used to confirm whether the user can see a particular advertisement outside the vehicle. In various examples, camera and/or time-of-flight sensors can be used to determine a position of the user's head, and direction of face and/or gaze.

In some examples, to identify the location of advertisements, the vehicle captures an image using an image sensor. In particular, the vehicle captures images of the environment around the vehicle. Thus, the image sensors capture images of scenes external to the vehicle. Additionally, audio sensors can be used to capture audio content of scenes external to the vehicle. Additional image sensors can also capture images inside the vehicle. Similarly, additional audio sensors can capture audio inside the vehicle. In addition to image sensors and audio sensors, other vehicle sensors capture information about the environment outside the vehicle, including LIDAR and RADAR sensors. In particular, in addition to camera images, the advertisement modification system can use LIDAR point clouds, radar feeds, audio sensor data, and ultraprecise GPS coordinates. The vehicle can continuously and/or repeatedly capture images and/or audio of the environment outside the vehicle, as the environment around the vehicle can be constantly changing as the vehicle moves and as objects (e.g., people, animals, and other vehicles) move around the vehicle.

At step 208, the contents of any visible advertisements are determined. The advertisement content can include the product, brand, holiday, theme, characters, etc. Sensor data, such as captured images of advertisements, are analyzed to determine the contents of the advertisements. In some examples, analyzing image data includes identifying various objects in the images of advertisements. Similarly, optical character recognition can be used to read text in advertisements. In various examples, a neural network can be used to learn to identify features and determine the contents of advertisements. Additionally, in some examples, a neural network can be trained to classify whether something is appropriate or inappropriate without actually identifying the features in the advertisements.

In various examples, vehicle sensors are used to detect advertisements and a vehicle perception stack identifies advertisement content. In some examples, map data is used in conjunction with vehicle sensor data, such that map data includes mapped locations of advertisements, while vehicle sensors detect the specific advertisements, and vehicle systems use sensor data to determine the locations of the advertisements in relation to the vehicle location. Additionally, vehicle sensors can be used to determine advertisement content. In some examples, advertisement content can be stored in the map data. However, in some examples, advertisement content can vary over time. Billboards and other physical advertisements are replaced periodically, and some advertisements can appear on large screens with frequently changing content. Sensors can be used to capture the content of advertisements and vehicle systems (e.g., a vehicle perception system, and/or an onboard computer) can be used to determine content of the advertisements using the sensor data.

At step 210, user preferences are evaluated. In various examples, user preferences are entered and saved in a user ridehail account. In particular, a ridehail account user can choose advertisement preferences. In some examples, advertisement preference options can include an option to block all advertisements, an option to block advertisements with selected content, an option to only show advertisements related to selected content, and/or an option to block advertisements with content that is not relevant to users below (or above) a certain age. In some examples, the ridehail application advertisement preferences section includes a list of potential advertisement content and a user can select from the list. The list can include specific product categories (e.g., various food products, beverages, clothing, appliances, electronics, etc.), specific brands, specific interests, specific holidays (e.g., Valentine's Day, Easter, Mother's Day, Memorial Day, Father's Day, Fourth of July, Veteran's Day, Thanksgiving, Christmas, Hanukkah, Kwanza, etc.), or other categories. Additionally, the ridehail application can provide a user with options such as “don't show advertisements from this company again” or “don't show advertisements for products like this again”, and the ridehail system can utilize user responses to learn user preferences over time.

At step 212, the content of the visible advertisements is compared with the user preferences. If the content includes matter that the user has opted out of seeing, the method proceeds to step 214. For example, if the content includes a reference to Valentine's Day, and the user has opted out of seeing advertisements related to Valentine's Day, the method proceeds to step 214. Similarly, if the content includes references to chocolate and the user has opted out of seeing advertisements for snacks and/or desserts, the method proceeds to step 214.

At step 214, it is determined whether to block or replace content. In some examples, a user preference may be to block advertisements in specific categories and/or for specific goods. In some examples, a user preference may be to block all advertisements. In some examples, the advertisement is simply blacked or grayed out. In some examples, advertisements may be replaced with non-commercial material (e.g., pictures or images of nature, buildings, etc.). In some examples, exterior advertisements are replaced with different advertisements.

The vehicle identifies the area of the window through which the advertisement is visible, which is continually updated since the area of the window through which the advertisement is visible changes as the vehicle moves. In various examples, a three dimensional space model is maintained in order to determine the intersection area in the window between the viewer and the advertisement and enable selective blocking. In particular, the intersection area is the area in the window through which the advertisement is visible to the viewer. In some examples, the entire window is made opaque for a period of time to block the advertisement. In some examples, the window is a transparent display screen. Depending on the determination at step 214, at step 216, the image visible at identified area is replaced. In some examples, the identified area of the window is dimmed or blocked such that the user cannot see through that section of the window. For instance, the windows can be designed to be able to transform from transparent glass to opaque digital screens, and in some examples, selected sections of the window can transform. In some examples, the identified area is replaced with a different image, such that the advertisement is not visible. In some examples, the replacement image is generated based on image analysis and perception system analyses, so that it appears over the selected area where the advertisement would otherwise be visible. The perception system can be used, for example, to replace or filter the advertisement. In some examples, the replacement image is projected on to the area of the window through which the advertisement is visible.

At step 212, if the content of the visible advertisements is compared with the user preferences and does not include matter that the user opted out of seeing, the method optionally proceeds to step 218. At step 218, the visible advertisement can be enhanced. For example, animation can be added to the advertisement, such that one or more objects in the advertisement move. A link or QR code can be added to the advertisement, such that the user can use their mobile device to quickly link to the advertised product. In some examples, a link or QR code can be added to save the advertisement to a user's personal account.

In some examples, interior vehicle features can be linked to an advertisement. For example, an interior screen can display the website for an advertised product. In another example, an in-vehicle screen can offer a user an option to stop at a venue presented in a visible advertisement (e.g., a retail store, a food store, a drive through, etc.).

Example System for Vehicle Advertisement Modification

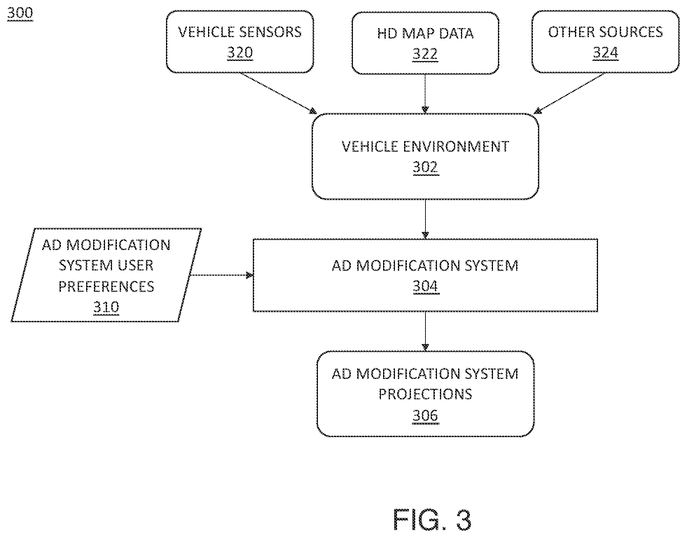

FIG. 3 illustrates an example 300 of the inputs to a system 304 for advertisement modification in a vehicle, according to some examples of the present disclosure. In particular, a vehicle environment 302 including any visible advertisements in the vehicle environment 302 is used by the advertisement modification system 304 to identify advertisement content, and block advertisements or generate advertisement replacements. The vehicle environment 302 is determined using several inputs. The inputs to the vehicle environment 302 include vehicle sensor data 320, map data 322, and input from other sources 324. The vehicle sensor data 320 includes data from vehicle cameras, LIDAR, radar, and other sensors. The vehicle map data 322 can include high definition, ultra-detailed maps used by the autonomous vehicle fleet for autonomous driving functions. The other sources of input from other sources 324 includes historical data, both data generated by autonomous vehicles and other data input to the system, 3D assets, including 3D models input into the system, as well as any other data sources. The autonomous vehicle environment 302 uses the various inputs to generate proprietary detailed maps including specific locations of various advertisements, which are then input to the advertisement modification system 304.

The advertisement modification system 304 receives as input the vehicle environment 302, as well as advertisement modification user preferences 310, and generates advertisement modification projection 306. For the user preferences 310, in various examples, a user is presented with the various advertisement modification options as described above. In some examples, the advertisement modification options are saved in user settings in a ridehail application. In some examples, advertisement modification options can be presented to a user via a ridehail application on the user mobile device before entering the vehicle. In some examples, once the user enters the vehicle, the advertisement modification options can be presented to the user on the user mobile device, the advertisement modification options can be presented on an in-vehicle tablet, and the advertisement modification options can be presented on an in-vehicle display screen. In various examples, advertisement modification options include blocking selected advertisements, replacing selected advertisements, and/or enhancing selected advertisements. In some examples, some advertisements are automatically enhanced and/or augmented without a selection from the user.

According to various examples, there are many reasons users may prefer not to see certain advertisements. For example, a user on a diet may not want to see advertisements for snacks, desserts, or certain types of foods. A user who is vegan may not want to see an advertisement for a steakhouse. Similarly, a user who has quit drinking alcohol may prefer not to see advertisements for alcohol. In another example, a user who is single or who recently ended a relationship may not want to see Valentine's Day advertisements. Some users may not like horror movies and may prefer not to see advertisements for scary shows and movies. In some examples, if a child is riding in the vehicle, a user may prefer the child not see any advertisements, or only advertisements for children's items. In some examples, the system can generate profile parameters based on a user's ride history, and in particular, based on pick-up and/or drop-off location of the user. For instance, if the user frequents vegetarian eateries and grocery stores, the user profile may be updated to indicate that the user is likely vegetarian.

The advertisement modification system user preferences 310 allow a user to adjust the settings at any time, such that some settings can be saved and generally applied to all rides, and settings can also be adjusted for any particular ride. In some examples, the advertisement modification system settings allow a user to save different settings for different users on an account. Thus, if an account includes multiple user profiles, different advertisement modification preferences can be saved for each user.

The methods 200 and 300 described with respect to FIGS. 2 and 3 can be applied to any content visible from a vehicle. Thus, while the description with respect to FIGS. 2 and 3 focuses on advertisements, the methods 200 and 300 can be used to modify any selected content.

Example Vehicle with Range of View for Advertisement Modification

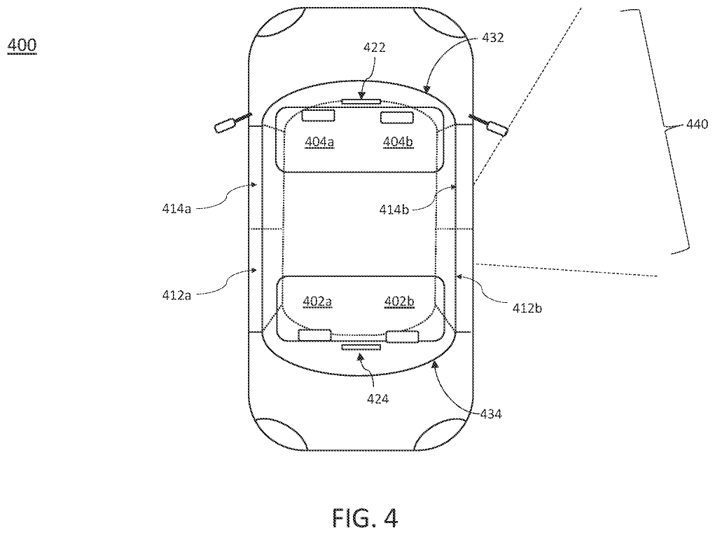

FIG. 4 shows a cutaway top view of a vehicle 400 with the interior seats facing each other, according to various embodiments of the disclosure. In particular, as shown in FIG. 4, a first row of seats includes two seats 402a, 402b facing a first direction and a second row of seats includes two seats 404a, 404b facing the opposite direction. The seats 402a, 402b in the first row face a display screen 422 and a front window 432. Similarly, the seats 404a, 404b in the second row face a display screen 424 and a rear window 434. There are also side windows next to each seat, with a first side window 412a next to the left first row seat 402a, a second side window 412b next to the right first row seat 402b, a third side window 414a next to the left second row seat, and a fourth side window 414b next to the right second row seat. In some examples, each of the windows (the front window 432, rear window 434, and the side windows 412a, 412b, 414a, 414b) displays the environment external to the autonomous vehicle 400. In some examples, advertisements visible through any of the windows (the front window 432, rear window 434, and the side windows 412a, 412b, 414a, 414b) can be modified. In some examples, the portion of the exterior environment visible to a passenger sitting in the rear right seat 402b is the portion outside the side window 412b and generally within the wedge 440 shown in FIG. 4. Thus, in some examples, for a passenger sitting in the rear right seat 402b, the advertisement modification system modifies advertisements in the area 440 defined by the dotted lines (where the dotted lines extend out as far as is visible to a vehicle passenger). The windows display a continuous scene such that a passenger in the vehicle 400 looking at any of the windows will see a portion of the environment, and the visible portion changes as the vehicle moves.

In various implementations, each seat 402a, 402b, 404a, 404b has a personal display screen, which can be lowered and/or retracted as needed. The personal display screen can display advertisements, links related to advertisements visible outside the vehicle, or entertainment, such as a show, movie, or game. According to various implementations, the passenger compartment includes a variety of sensors. In some examples, the passenger compartment is equipped with image sensors. The image sensors can include video cameras. Each image sensor is configured to capture images of a portion of the passenger compartment. In one example, each row of seats 402a, 402b and 404a, 404b has two or more image sensors above it and facing the opposite row of seats. In some examples, the passenger compartment sensors include microphones for capturing audio, e.g., voices of passengers in the passenger compartment. In some examples, the sensors can be used to determine whether a passenger is engaging with an advertisement visible outside the vehicle. In some examples, when a user engages with an advertisement visible outside the vehicle, links related to the advertisement, such as a product website, an online store to purchase a product, and/or a physical store to purchase the product can be displayed on the personal screen. In some examples, instead of blocking an advertisement, the vehicle distracts the user from looking out a selected window towards the advertisement and draws the user's attention to an interior screen, a different window, or some other item.

In some examples, the windows 432, 434, 412a, 412b, 414a, 414b are controlled individually. For example, the windows 432, 434, 412a, 412b, 414a, 414b can be controlled separately so that each passenger has different modified advertisements visible through their respective window 412a, 412b, 414a, 414b, 432, 434.

In some examples, passenger compartment sensors, such as image sensors and microphones, are in communication with the advertisement modification system. In some examples, to determine whether a seat has a seated passenger, the onboard computer may perform an image detection algorithm on images captured by image sensors. As another example, the passenger compartment includes weight sensors incorporated into the passenger seats that transmit weight measurements to the onboard computer, and the onboard computer determines based on the weight measurements whether each seat has a seated passenger. In other embodiments, the onboard computer uses one or more other interior sensors (e.g., LIDAR, RADAR, thermal imaging, etc.) or a combination of sensors to identify the locations of passengers seated in the autonomous vehicle. In some implementations, the advertisement modification system instructs image sensors directed at seats that have seated passengers to capture video, while other image sensors do not capture video. In some examples, weight and image sensors are used to recommend age-specific advertisement modifications to passengers. For instance, based on weight detected in the car seats (and potentially integrating with computer vision from internal image sensors), the approximate age of each of one or more passengers can be estimated and age-appropriate advertisement modifications can be recommended.

In some implementations, one or more of the windows 412a, 412b, 414a, 414b, 432, 434 are in communication with and are controlled by one or both of the advertisement modification system and the onboard computer. In one example, the windows 412a, 412b, 414a, 414b, 432, 434 are in communication with and are controlled by the advertisement modification system, while the display screens 422, 424 are in communication with and are controlled by the onboard computer. In another example, one or more of the windows 412a, 412b, 414a, 414b, 432, 434, and other output devices (e.g., speakers) are controlled by a separate computer (e.g., a computer integrated with one of the windows or located elsewhere in the autonomous vehicle). The separate computer can be associated with the advertisement modification reality system. In some examples, the computer controlling one or more of the windows 412a, 412b, 414a, 414b, 432, 434 is in communication with a fleet management system. The computer controlling the windows 412a, 412b, 414a, 414b, 432, 434 can receive user input from one or more input sources described above, such as a touch screen, microphone, buttons, user interface device, personal user device, or one or more other user input devices. The computer controlling the windows 412a, 412b, 414a, 414b, 432, 434 may or may not interact with the onboard computer.

Example Device for Content Modification Preferences

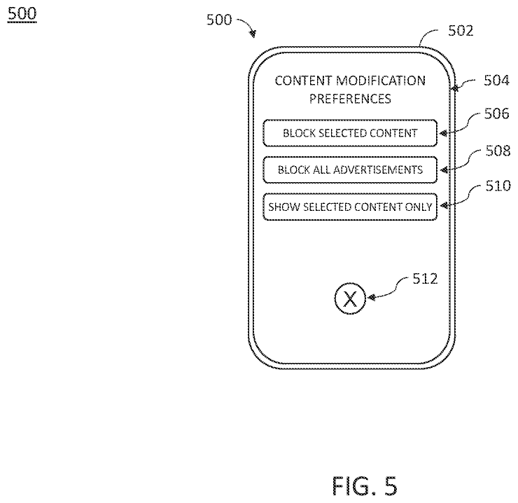

FIG. 5 shows an example 500 of a device interface for entering user preferences for modification of content visible from (and/or within) a vehicle, according to some embodiments of the disclosure. In particular, FIG. 5 shows an example 500 of a device 502 showing a rideshare application interface 504 providing the user with three options (buttons) with respect to modifying content. In some examples, the interface is available under user settings in a ridehail application, and user preferences are entered and saved in a user ridehail account. In particular, a ridehail account user can choose advertisement preferences. In some examples, advertisement preference options can include an option to block advertisements with selected content (button 506), an option to block all advertisements (button 508), and an option to only show advertisements related to selected content (button 610). The “x” button 612 can be used to exit the content modification preferences menu.

In some examples, when the user selects the button 506, the ridehail application content preferences section includes a list of potential advertisement content and a user can select from the list any content the user would like blocked. Similarly, in some examples, when the user selects the button 610, the ridehail application content preferences section includes a list of potential advertisement content and a user can select from the list the content the user would like displayed, enhanced, and/or augmented. The list can include specific product categories (e.g., various food products, beverages, clothing, appliances, electronics, etc.), specific brands, specific interests, specific holidays (e.g., Valentine's Day, Easter, Mother's Day, Memorial Day, Father's Day, Fourth of July, Veteran's Day, Thanksgiving, Christmas, Hanukkah, Kwanza, etc.), or other categories. Thus, in one example, a user can elect to block all content related to snacks, chocolate, candy, and flowers, but ask to be shown content related to Valentine's Day, and content such as Valentine's Day gift advertisements for items other than snacks, chocolate, candy, and flowers will be shown. Additionally, the ridehail application can provide a user with options such as “don't show advertisements from this company again” or “don't show advertisements for products like this again”, and the ridehail system can utilize user responses to learn user preferences over time.

Example Systems for Vehicle Content Modification

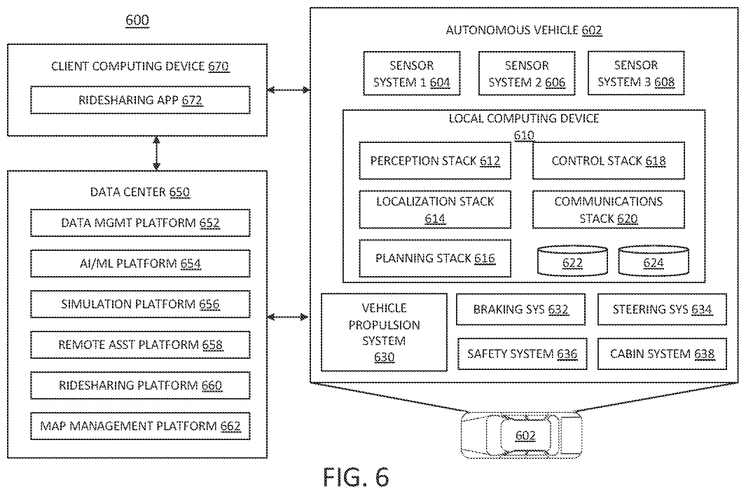

Turning now to FIG. 6, this figure illustrates an example of an AV management system 600. One of ordinary skill in the art will understand that, for the AV management system 600 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 600 includes an AV 602, a data center 650, and a client computing device 670. The AV 602, the data center 650, and the client computing device 670 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 602 can navigate about roadways without a human driver based on sensor signals generated by multiple sensor systems 604, 606, and 608. The sensor systems 604-608 can include different types of sensors and can be arranged about the AV 602. For instance, the sensor systems 604-608 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 604 can be a camera system, the sensor system 606 can be a LIDAR system, and the sensor system 608 can be a RADAR system. Other embodiments may include any other number and type of sensors.

AV 602 can also include several mechanical systems that can be used to maneuver or operate AV 602. For instance, the mechanical systems can include vehicle propulsion system 630, braking system 632, steering system 634, safety system 636, and cabin system 638, among other systems. Vehicle propulsion system 630 can include an electric motor, an internal combustion engine, or both. The braking system 632 can include an engine brake, a wheel braking system (e.g., a disc braking system that utilizes brake pads), hydraulics, actuators, and/or any other suitable componentry configured to assist in decelerating AV 602. The steering system 634 can include suitable componentry configured to control the direction of movement of the AV 602 during navigation. Safety system 636 can include lights and signal indicators, a parking brake, airbags, and so forth. The cabin system 638 can include cabin temperature control systems, in-cabin entertainment systems, and so forth. In some embodiments, the AV 602 may not include human driver actuators (e.g., steering wheel, handbrake, foot brake pedal, foot accelerator pedal, turn signal lever, window wipers, etc.) for controlling the AV 602. Instead, the cabin system 638 can include one or more client interfaces (e.g., Graphical User Interfaces (GUIs), Voice User Interfaces (VUIs), etc.) for controlling certain aspects of the mechanical systems 630-638.

AV 602 can additionally include a local computing device 610 that is in communication with the sensor systems 604-608, the mechanical systems 630-638, the data center 650, and the client computing device 670, among other systems. The local computing device 610 can include one or more processors and memory, including instructions that can be executed by the one or more processors. The instructions can make up one or more software stacks or components responsible for controlling the AV 602; communicating with the data center 650, the client computing device 670, and other systems; receiving inputs from riders, passengers, and other entities within the AV's environment; logging metrics collected by the sensor systems 604-608; and so forth. In this example, the local computing device 610 includes a perception stack 612, a mapping and localization stack 614, a planning stack 616, a control stack 618, a communications stack 620, a High Definition (HD) geospatial database 622, and an AV operational database 624, among other stacks and systems.

Perception stack 612 can enable the AV 602 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 604-608, the mapping and localization stack 614, the HD geospatial database 622, other components of the AV, and other data sources (e.g., the data center 650, the client computing device 670, third-party data sources, etc.). The perception stack 612 can detect and classify objects and determine their current and predicted locations, speeds, directions, and the like. In addition, the perception stack 612 can determine the free space around the AV 602 (e.g., to maintain a safe distance from other objects, change lanes, park the AV, etc.). The perception stack 612 can also identify environmental uncertainties, such as where to look for moving objects, flag areas that may be obscured or blocked from view, and so forth.

The autonomous vehicle 602 includes multiple windows. In some examples, the windows are transparent screens. An advertisement modification system can used data from the perception stack to identify various advertisements and determine the locations of the various advertisements. The advertisement modification system can block, augment, or enhance the advertisements using the transparent screens, by making one or more selected areas of a window opaque or otherwise changing the view at the selected area(s). In some examples, the advertisement modification system can project something onto an area of a window to block, change, augment, and/or enhance an advertisement. In some examples, the entire window can be modified to block, change, augment, and/or enhance an advertisement.

Mapping and localization stack 614 can determine the AV's position and orientation (pose) using different methods from multiple systems (e.g., GPS, IMUs, cameras, LIDAR, RADAR, ultrasonic sensors, the HD geospatial database 622, etc.). For example, in some embodiments, the AV 602 can compare sensor data captured in real-time by the sensor systems 604-608 to data in the HD geospatial database 622 to determine its precise (e.g., accurate to the order of a few centimeters or less) position and orientation. The AV 602 can focus its search based on sensor data from one or more first sensor systems (e.g., GPS) by matching sensor data from one or more second sensor systems (e.g., LIDAR). If the mapping and localization information from one system is unavailable, the AV 602 can use mapping and localization information from a redundant system and/or from remote data sources.

The planning stack 616 can determine how to maneuver or operate the AV 602 safely and efficiently in its environment. For example, the planning stack 616 can receive the location, speed, and direction of the AV 602, geospatial data, data regarding objects sharing the road with the AV 602 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 602 from one point to another. The planning stack 616 can determine multiple sets of one or more mechanical operations that the AV 602 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 616 can select from multiple backup plans to carry out. For example, while preparing to change lanes to turn right at an intersection, another vehicle may aggressively cut into the destination lane, making the lane change unsafe. The planning stack 616 could have already determined an alternative plan for such an event, and upon its occurrence, help to direct the AV 602 to go around the block instead of blocking a current lane while waiting for an opening to change lanes.

The control stack 618 can manage the operation of the vehicle propulsion system 630, the braking system 632, the steering system 634, the safety system 636, and the cabin system 638. The control stack 618 can receive sensor signals from the sensor systems 604-608 as well as communicate with other stacks or components of the local computing device 610 or a remote system (e.g., the data center 650) to effectuate operation of the AV 602. For example, the control stack 618 can implement the final path or actions from the multiple paths or actions provided by the planning stack 616. This can involve turning the routes and decisions from the planning stack 616 into commands for the actuators that control the AV's steering, throttle, brake, and drive unit.

The communication stack 620 can transmit and receive signals between the various stacks and other components of the AV 602 and between the AV 602, the data center 650, the client computing device 670, and other remote systems. The communication stack 620 can enable the local computing device 610 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MU LTEFIRE, etc.). The communication stack 620 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 622 can store HD maps and related data of the streets upon which the AV 602 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 624 can store raw AV data generated by the sensor systems 604-608 and other components of the AV 602 and/or data received by the AV 602 from remote systems (e.g., the data center 650, the client computing device 670, etc.). In some embodiments, the raw AV data can include HD LIDAR point cloud data, image or video data, RADAR data, GPS data, and other sensor data that the data center 650 can use for creating or updating AV geospatial data as discussed further below with respect to FIG. 5 and elsewhere in the present disclosure.

The data center 650 can be a private cloud (e.g., an enterprise network, a co-location provider network, etc.), a public cloud (e.g., an Infrastructure as a Service (laaS) network, a Platform as a Service (PaaS) network, a Software as a Service (SaaS) network, or other Cloud Service Provider (CSP) network), a hybrid cloud, a multi-cloud, and so forth. The data center 650 can include one or more computing devices remote to the local computing device 610 for managing a fleet of AVs and AV-related services. For example, in addition to managing the AV 602, the data center 650 may also support a ridesharing service, a delivery service, a remote/roadside assistance service, street services (e.g., street mapping, street patrol, street cleaning, street metering, parking reservation, etc.), and the like.

The data center 650 can send and receive various signals to and from the AV 602 and the client computing device 670. These signals can include sensor data captured by the sensor systems 604-608, roadside assistance requests, software updates, ridesharing pick-up and drop-off instructions, and so forth. In this example, the data center 650 includes one or more of a data management platform 652, an Artificial Intelligence/Machine Learning (AI/ML) platform 654, a simulation platform 656, a remote assistance platform 658, a ridesharing platform 660, and a map management platform 662, among other systems.

Data management platform 652 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 650 can access data stored by the data management platform 652 to provide their respective services.

The AI/ML platform 654 can provide the infrastructure for training and evaluating machine learning algorithms for operating the AV 602, the simulation platform 656, the remote assistance platform 658, the ridesharing platform 660, the map management platform 662, and other platforms and systems. Using the AI/ML platform 654, data scientists can prepare data sets from the data management platform 652; select, design, and train machine learning models; evaluate, refine, and deploy the models; maintain, monitor, and retrain the models; and so on.

The simulation platform 656 can enable testing and validation of the algorithms, machine learning models, neural networks, and other development efforts for the AV 602, the remote assistance platform 658, the ridesharing platform 660, the map management platform 662, and other platforms and systems. The simulation platform 656 can replicate a variety of driving environments and/or reproduce real-world scenarios from data captured by the AV 602, including rendering geospatial information and road infrastructure (e.g., streets, lanes, crosswalks, traffic lights, stop signs, etc.) obtained from the map management platform 662; modeling the behavior of other vehicles, bicycles, pedestrians, and other dynamic elements; simulating inclement weather conditions, different traffic scenarios; and so on.

The remote assistance platform 658 can generate and transmit instructions regarding the operation of the AV 602. For example, in response to an output of the AI/ML platform 654 or other system of the data center 650, the remote assistance platform 658 can prepare instructions for one or more stacks or other components of the AV 602.

The ridesharing platform 660 can interact with a customer of a ridesharing service via a ridesharing application 672 executing on the client computing device 670. The client computing device 670 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 672. The client computing device 670 can be a customer's mobile computing device or a computing device integrated with the AV 602 (e.g., the local computing device 610). The ridesharing platform 660 can receive requests to be picked up or dropped off from the ridesharing application 672 and dispatch the AV 602 for the trip.

Map management platform 662 can provide a set of tools for the manipulation and management of geographic and spatial (geospatial) and related attribute data. The data management platform 652 can receive LIDAR point cloud data, image data (e.g., still image, video, etc.), RADAR data, GPS data, and other sensor data (e.g., raw data) from one or more AVs 602, Unmanned Aerial Vehicles (UAVs), satellites, third-party mapping services, and other sources of geospatially referenced data. The raw data can be processed, and map management platform 662 can render base representations (e.g., tiles (2D), bounding volumes (3D), etc.) of the AV geospatial data to enable users to view, query, label, edit, and otherwise interact with the data. Map management platform 662 can manage workflows and tasks for operating on the AV geospatial data. Map management platform 662 can control access to the AV geospatial data, including granting or limiting access to the AV geospatial data based on user-based, role-based, group-based, task-based, and other attribute-based access control mechanisms. Map management platform 662 can provide version control for the AV geospatial data, such as to track specific changes that (human or machine) map editors have made to the data and to revert changes when necessary. Map management platform 662 can administer release management of the AV geospatial data, including distributing suitable iterations of the data to different users, computing devices, AVs, and other consumers of HD maps. Map management platform 662 can provide analytics regarding the AV geospatial data and related data, such as to generate insights relating to the throughput and quality of mapping tasks.

In some embodiments, the map viewing services of map management platform 662 can be modularized and deployed as part of one or more of the platforms and systems of the data center 650. For example, the AI/ML platform 654 may incorporate the map viewing services for visualizing the effectiveness of various object detection or object classification models, the simulation platform 656 may incorporate the map viewing services for recreating and visualizing certain driving scenarios, the remote assistance platform 658 may incorporate the map viewing services for replaying traffic incidents to facilitate and coordinate aid, the ridesharing platform 660 may incorporate the map viewing services into the client application 672 to enable passengers to view the AV 602 in transit en route to a pick-up or drop-off location, and so on.

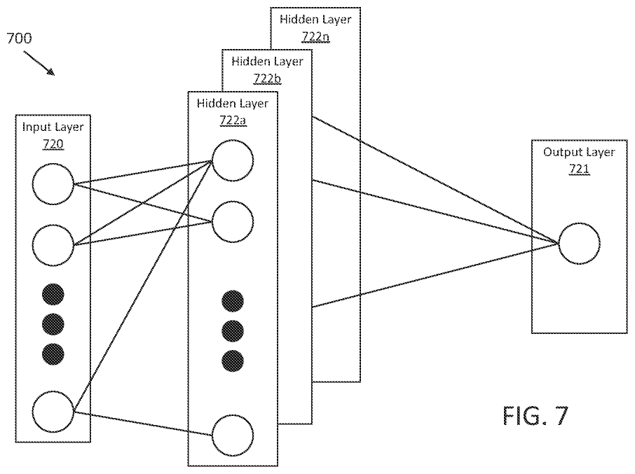

In FIG. 7, the disclosure now turns to a further discussion of models that can be used through the environments and techniques described herein. Specifically, FIG. 7 is an illustrative example of a deep learning neural network 700 that can be used to implement all or a portion of a perception module (or perception system) as discussed above. An input layer 720 can be configured to receive sensor data and/or data relating to an environment surrounding an AV. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network 700 further includes an output layer 721 that provides an output resulting from the processing performed by the hidden layers 722a, 722b, through 722n. In one illustrative example, the output layer 721 can provide estimated treatment parameters, that can be used/ingested by a differential simulator to estimate a patient treatment outcome.

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target−output)²). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

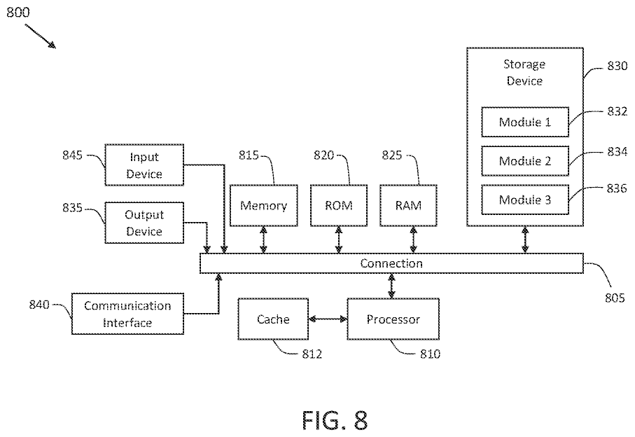

FIG. 8 illustrates an example processor-based system with which some aspects of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an (BEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASH EPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### Selected Examples

Example 1 provides a method for advertisement modification in a vehicle, comprising: identifying a visible advertisement in a vehicle environment; determining a plurality of features of the visible advertisement; evaluating user advertisement preferences from a user account to identify selected content; determining that at least one of the plurality of features match the selected content; modifying the visible advertisement to change the at least one of the plurality of features and generating a modified advertisement; and displaying the modified advertisement on a vehicle window.

Example 2 provides a method, system, and/or vehicle according to one or more of the preceding and/or following examples, wherein evaluating user advertisement preferences to identify selected content includes evaluating user advertisement preferences to identify preferably avoided content.

Example 3 provides a method, system, and/or vehicle according to one or more of the preceding and/or following examples, wherein modifying the visible advertisement to change the at least one of the plurality of features includes blocking the at least one of the plurality of features.

Example 4 provides a method, system, and/or vehicle according to one or more of the preceding and/or following examples, wherein blocking the at least one of the plurality of features includes replacing the at least one of the plurality of features with different content.

Example 5 provides a method, system, and/or vehicle according to one or more of the preceding and/or following examples, wherein evaluating user advertisement preferences to identify selected content includes evaluating user advertisement preferences to identify preferred content.

Example 6 provides a method, system, and/or vehicle according to one or more of the preceding and/or following examples, wherein modifying the visible advertisement to change the at least one of the plurality of features includes enhancing the at least one of the plurality of features.

Example 7 provides a method, system, and/or vehicle according to one or more of the preceding and/or following examples, further comprising identifying a selected window area, wherein the selected window area is a portion of the vehicle window through which the visible advertisement is visible.

Example 8 provides a method, system, and/or vehicle according to one or more of the preceding and/or following examples, wherein displaying the modified advertisement on the vehicle window includes displaying the modified advertisement on the selected window area.

Example 9 provides a method, system, and/or vehicle according to one or more of the preceding and/or following examples, wherein displaying the modified advertisement includes projecting the modified advertisement on the vehicle window.

Example 10 provides a vehicle for providing advertisement modification, comprising: a sensor suite including external vehicle sensors to sense a vehicle environment and generate sensor data; a perception system to receive the sensor data and to acquire map data and to use the map data and the sensor data to identify a visible advertisement and determine a location of the visible advertisement; and an advertisement modification system to: receive the visible advertisement and the advertisement location; evaluate an advertisement modification user preference to identify selected content; generate a modified advertisement; and display the modified advertisement on an interior vehicle window.

Example 11 provides a method, system, and/or vehicle according to one or more of the preceding and/or following examples, wherein the interior vehicle window is a transparent screen, and wherein the advertisement modification system is further to display the modified advertisement by adjusting a display on a selected area of the transparent screen.

Example 12 provides a method, system, and/or vehicle according to one or more of the preceding and/or following examples, wherein the perception system is further to identify a selected window area, wherein the selected window area is a portion of the interior vehicle window through which the at least one advertisement is visible.

Example 13 provides a method, system, and/or vehicle according to one or more of the preceding and/or following examples, wherein the advertisement modification system is further to determine a plurality of features of the visible advertisement and determine that at least one of the plurality of features match the selected content.

Example 14 provides a method, system, and/or vehicle according to one or more of the preceding and/or following examples, wherein the advertisement modification system is further to block the at least one of the plurality of features.

Example 15 provides a method, system, and/or vehicle according to one or more of the preceding and/or following examples, wherein the advertisement modification system is further to enhance the at least one of the plurality of features.

Example 16 provides system for providing advertisement modification, comprising: a central computer to transmit map data; and a vehicle including: a sensor suite including external vehicle sensors to sense a vehicle environment and generate sensor data; a perception system to receive the sensor data and to receive the map data and to use the map data and the sensor data to identify at least one visible advertisement and determine a location of the at least one visible advertisement; and an advertisement modification system to: receive the at least one visible advertisement and the at least one visible advertisement location; receive an advertisement modification user preference including flagged content; generate a modified advertisement to change the flagged content in the at least one visible advertisement; and display the modified advertisement on an interior vehicle window.

Example 17 provides a method, system, and/or vehicle according to one or more of the preceding and/or following examples, wherein the interior vehicle window is a transparent screen, and wherein the advertisement modification system is further to display the modified advertisement by adjusting a display on a selected area of the transparent screen.

Example 18 provides a method, system, and/or vehicle according to one or more of the preceding and/or following examples, wherein the perception system is further to identify a selected window area, wherein the selected window area is a portion of the interior vehicle window through which the at least one advertisement is visible, and wherein the advertisement modification system is to display the modified advertisement in the selected window area.

Example 19 provides a method, system, and/or vehicle according to one or more of the preceding and/or following examples, wherein the advertisement modification system is further to determine a plurality of features of the at least one visible advertisement and determine that at least one of the plurality of features match the flagged content.

Example 20 provides a method, system, and/or vehicle according to one or more of the preceding and/or following examples, wherein the advertisement modification system is further to block at least one of the plurality of features.

Example 21 provides a method, system, and/or vehicle according to one or more of the preceding and/or following examples, wherein the advertisement modification system is further to enhance the at least one of the plurality of features.

Example 22 provides an apparatus comprising means for performing the method of any of the previous examples.

Example 23 provides a method for advertisement modification of publicly viewable content in a vehicle, comprising: identifying visible content in a vehicle environment; determining at least one feature of the visible content; evaluating user content preferences from a user account to identify selected content; determining that the at least one feature matches the selected content; modifying the visible content to change the at least one feature and generating modified content; and displaying the modified content on a vehicle window.

Example 24 provides a vehicle for providing content modification, comprising: a sensor suite including external vehicle sensors to sense a vehicle environment and generate sensor data; and a content modification system to: receive visible content and content location; evaluate a content modification user preference to identify selected content; generate modified content; and display the modified content on an interior vehicle window.

Example 25 provides a system for providing content modification, comprising: a central computer to transmit map data and visible content data; and a vehicle including: a sensor suite including external vehicle sensors to sense a vehicle environment and generate sensor data; and a content modification system to: receive visible content data and visible content location; receive a content modification user preference including flagged content; generate modified content to change the flagged content in the visible content data; and display the modified content on an interior vehicle window.

Example 26 provides a vehicle for providing content modification, comprising: a sensor suite including external vehicle sensors to sense a vehicle environment and generate sensor data; and a content modification system to: receive visible content and content location; evaluate a content modification user preference to identify selected content; and modify window transparency of a vehicle window to prevent viewing of the visible content.

Example 27 provides a method for advertisement modification in a vehicle, comprising: identifying a visible advertisement in a vehicle environment; determining a plurality of features of the visible advertisement; evaluating user advertisement preferences from a user account to identify selected content; determining that at least one of the plurality of features match the selected content; modifying transparency of a vehicle window to prevent viewing of the visible content.

Example 28 provides a method, system, and/or vehicle according to one or more of the preceding and/or following examples wherein the content modification system is further to: generate modified content; and display the modified content on an interior of the vehicle window.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

1. A method for advertisement modification of publicly viewable content in a vehicle, comprising:
identifying visible advertisement content in an external vehicle environment;
determining, using a neural network, at least one feature of the visible advertisement content;
evaluating user content preferences from a user account to identify selected undesirable content;
determining that the at least one feature matches a portion of the selected undesirable content;
modifying the visible advertisement content to change the at least one feature and generating modified content;
displaying the modified content on a vehicle window;
generating in-vehicle content corresponding to the modified content wherein the in-vehicle content is displayed on an in-vehicle tablet and wherein the in-vehicle content includes one or more of a link, a QR code, and animated content.

2. The method of claim 1, wherein evaluating user content preferences to identify selected undesirable content includes evaluating user content preferences to identify preferably avoided content.

3. The method of claim 2, wherein modifying the visible advertisement content to change the at least one feature includes blocking the at least one feature.

4. The method of claim 3, wherein blocking the at least one feature includes replacing the at least one feature with different content.

5. The method of claim 1, wherein evaluating user content preferences to identify selected undesirable content includes evaluating user content preferences to identify preferred content.

6. The method of claim 5, wherein modifying the visible advertisement content to change the at least one feature includes enhancing the at least one feature.

7. The method of claim 1, further comprising identifying a selected window area, wherein the selected window area is a portion of the vehicle window through which the visible advertisement content is viewable, and wherein displaying the modified content on the vehicle window includes displaying the modified content on the selected window area.

8. (canceled)

9. The method of claim 1, wherein displaying the modified content includes projecting the modified content on the vehicle window.

10. A vehicle for providing content modification, comprising:
a sensor suite including external vehicle sensors to sense an external vehicle environment and generate sensor data; and
a content modification system to:
receive, based on the sensor data, visible advertisement content and content location of the advertisement content, wherein the content location is in the external vehicle environment;
evaluate a content modification user preference to identify selected undesirable content;
determine that at least one feature of the visible advertisement content matches a portion of the selected undesirable content
generate modified advertisement content;
modify window transparency of a vehicle window to prevent viewing of the visible advertisement content from inside the vehicle; and
generate in-vehicle content corresponding to the modified advertisement content wherein the in-vehicle content is displayed on an in-vehicle tablet and wherein the in-vehicle content includes one or more of a link, a QR code, and animated content.

11. The vehicle of claim 10, wherein the content modification system is further to
display the modified advertisement content on an interior of the vehicle window.

12. The vehicle of claim 11, wherein the vehicle window is a transparent screen, and wherein the content modification system is further to display the modified advertisement content by adjusting a display on a selected area of the transparent screen.

13. The vehicle of claim 10, further comprising a perception system to receive the sensor data and to acquire map data and to use the map data and the sensor data to identify the visible advertisement content and determine the content location.

14. The vehicle of claim 13, wherein the perception system is further to identify a selected window area, wherein the selected window area is a portion of the interior vehicle window through which visible advertisement content is viewable.

15. The vehicle of claim 10, wherein the content modification system is further to:
determine a plurality of features of the visible advertisement content;
determine that at least one of the plurality of features match the selected content; and
at least one of:
block the at least one of the plurality of features, and
enhance the at least one of the plurality of features.

16. A system for providing content modification, comprising:
a central computer to transmit map data and visible advertisement content data; and
a vehicle including:
a sensor suite including external vehicle sensors to sense an external vehicle environment and generate sensor data; and
a content modification system to:
receive, based on the sensor data and map data, visible advertisement content and content location of the advertisement content, wherein the content location is in the external vehicle environment;
receive a content modification user preference including flagged content;
generate modified advertisement content to change the flagged content in the visible advertisement content data;
display the modified advertisement content on an interior vehicle window; and
generate in-vehicle content corresponding to the modified advertisement content wherein the in-vehicle content is displayed on an in-vehicle tablet and wherein the in-vehicle content includes one or more of a link, a QR code, and animated content.

17. The system of claim 16, wherein the interior vehicle window is a transparent screen, and wherein the advertisement modification system is further to display the modified advertisement content by adjusting a display on a selected area of the transparent screen.

18. The system of claim 16, further comprising a perception system to:
receive the sensor data and to receive the map data,
use the map data and the sensor data to identify the visible advertisement content data and determine a relative location of the visible advertisement content, and
identify a selected window area, wherein the selected window area is a portion of the interior vehicle window through which the visible advertisement content is viewable, and
wherein the content modification system is to display the modified advertisement content in the selected window area.

19. The system of claim 16, wherein the advertisement modification system is further to determine a plurality of features of the visible advertisement content and determine that at least one of the plurality of features match the flagged content.

20. The system of claim 19, wherein the advertisement modification system is further to one of: block the at least one of the plurality of features, and enhance the at least one of the plurality of features.

21. The system of claim 16, wherein the visible advertisement content data transmitted by the central computer includes a plurality of advertisements visible from the vehicle and wherein the map data includes an exact location of each of the plurality of advertisements.
